(19) United States
(12) Patent Application Publication
(10) Pub. No.: US 2023/0313559 A1
(43) Pub. Date: Oct. 5, 2023

(54) Rapid Lockdown Device

(71) Applicant: Steven Olimpio, Kinnelon, NJ (US)

(72) Inventor: Steven Olimpio, Kinnelon, NJ (US)

(21) Appl. No.: 17/713,298

(22) Filed: Apr. 5, 2022

(51) Int. Cl. E05B 15/02; E05B 65/10

(52) U.S. Cl. CPC E05B 15/022; E05B 65/10

(57) ABSTRACT

A rapid lockdown device of embodiments of the disclosed technology includes a planar component rotatable about a screw portal located at a first end thereof. The planar component is adapted to be rotatably held against a strike plate of a door post via a screw extending through the screw portal. The device is rotatable into at least two positions: A blocking position, wherein the rectangular planar component is situated between a latch bolt of the door and a door frame; and an unblocking position, wherein the rectangular planar component, while being held by the screw to the strike plate, is positioned such that movement of the latch bolt towards the door frame is unencumbered.

### FIELD OF THE DISCLOSED TECHNOLOGY

The disclosed technology relates generally to door locks, and more specifically, to a door lock addition for blocking or unblocking a door lock.

### BACKGROUND OF THE DISCLOSED TECHNOLOGY

In the past few years, high focus has been placed on the importance of schools being prepared for potential dangerous scenarios. In some of these scenarios, such as an active shooter situation, schools focus on keeping teachers, students, and staff locked down and hidden, rather than risking them meeting a shooter while attempting to flee. To keep lockdowns safe, it is necessary that every room in the building be able to quickly lock their doors. Often, however, school door locks may be cumbersome to turn, especially when the person trying to lock the door is nervous. Therefore, there is a need for a way to ensure that doors may be quickly and easily locked in case of an emergency.

### SUMMARY OF THE DISCLOSED TECHNOLOGY

A rapid lockdown device of embodiments of the disclosed technology includes a rotatable planar component with a screw portal substantially at a first end thereof. The planar component is adapted to be rotatably held against a strike plate of a door post via a screw extending through the screw portal.

A most elongated flat side of the planar component is rotatable within a plane which is parallel to the strike plate about the screw. The planar component may be rotated into at least two positions: a blocking position, and an unblocking position. In the blocking position, the rectangular planar component is situated between a latch bolt of the door and a door frame. In the unblocking position, the rectangular planar component, while being held by the screw to the strike plate, is positioned such that movement of the latch bolt towards the door frame is unencumbered.

In some embodiments, the rapid lockdown device also has an internal rectangular cutout. The planar component may be substantially rectangular, and the screw portal substantially circular.

In various embodiments, a width of the device, that is to say a distance between a point of a first largest planar face thereof and a corresponding point of a second largest planar face thereof, is less than a width between a point of the door post and a corresponding point of a door corresponding thereto.

The rapid lockdown device, in some embodiments, has a male or female side of a hook and loop fastening. A corresponding opposite female or male hook and loop fastening side may be disposed on the door and/or on a doorpost at a location corresponding to the device's hook and loop fastening when the device is in the blocking position.

The rapid lockdown device may further have a magnet on the planar component. A corresponding magnet is, in some embodiments, disposed on the doorpost and/or on the door at a location corresponding to the magnet on the planar component when the planar component is in the blocking position.

In embodiments of the disclosed technology, the rapid lockdown device has a magnet disposed on the planar component. An entirety and/or a portion of the doorpost and/or the door may be a corresponding magnet.

When the device is in the unblocking position, magnetic force exerted between the magnet and the corresponding magnet may be insufficient to cause the device to rotate to the blocking position. By contrast, when the device is in the blocking position, the same magnetic force exerted between said magnet and the corresponding magnet is sufficient to substantially immobilize the device in the blocking position unless acted upon by external forces greater than and/or in a different vector from typical force due to gravity.

In some embodiments, the rapid lockdown device includes an internal rectangular portion with a friction coefficient substantially higher than a friction coefficient of a rest of the device. The higher friction coefficient of the internal rectangle is, in embodiments, sufficient to keep the device substantially immobile, at least with respect to rotation about the screw in at least the blocking and unblocking positions, when the device is between the door and a corresponding door post and/or door frame.

In some embodiments, the screw portal is substantially vertically above the latch bolt. As such, in the blocking position, the device is substantially at a same angle to the door as the strike plate and the screw portal is above a majority of the rapid lockdown device.

In various embodiments, a width of the device is smaller than a width of the strike plate and/or the door post. As such, when the device is substantially at a same angle to the door post as the strike plate, substantially an entirety of the device is between a plane corresponding to a front of the door post and a plane corresponding to a back of the door post. The front and back of the door post are substantially perpendicular to the strike plate.

The rapid lockdown device, in some embodiments, has indicia on a face thereof opposite a face thereof corresponding to the door post, such as instructions for using the device and/or emergency procedures.

At least in the blocking position, a vertical length of the device, in embodiments, is equal to or greater than a vertical length of the door lock.

A method of using the above-described rapid lockdown device of includes steps of: rotatably positioning the device in the blocking position; locking the door (such that the latch bolt is extended from the door and is impeded by the device); and rotatably positioning the device in the unblocking position (such that the latch bolt is extended from the door and is unencumbered by the device).

The method of use may further include a step of opening the door before rotatably positioning the device in the blocking position. Following the step of rotatably positioning the device in the blocking position, the method, in some embodiments, includes a step of closing the door, such that the device is located between the strike panel and a latch bolt of the door.

Additionally, the method of use may include a step of opening the door before the step of rotatably positioning the device in the unblocking position.

Following the step of rotatably positioning the device in the unblocking position, the method, in some embodiments, includes a step of closing the door, such that the device is located between the door frame and the door.

In embodiments, the steps of rotatably positioning the device in the blocking and/or unblocking position include rotating the device by exerting pressure within an internal rectangular cutout of the device.

In some embodiments, the step of rotatably positioning the device in the unblocking position is preceded by a step of disconnecting a hook and loop component of the device from a first corresponding hook and loop component at a position corresponding to the blocking position. Furthermore, the step of rotatably positioning the device in the unblocking position is followed by a step of connecting the hook and loop component of the device to a second corresponding hook and loop component at a position corresponding to the unblocking position.

Likewise, in embodiments, the step of rotatably positioning the device in the blocking position is preceded by a step of disconnecting the hook and loop component of the device from the second corresponding hook and loop component. Furthermore, the step of rotatably positioning the device in the blocking position is followed by connecting the hook and loop component of the device to the first corresponding hook and loop component. The first and second corresponding hook and loop components are disposed on the door and/or the door frame.

In other embodiments, the step of rotatably positioning the device in the unblocking position is preceded by a step of disconnecting a magnetic component of the device from a first corresponding magnetic component at a position corresponding to the blocking position. Furthermore, the step of rotatably positioning the device in the unblocking position is followed by a step of connecting the magnetic component of the device to a second corresponding magnetic component at a position corresponding to the unblocking position.

Likewise, in embodiments, the step of rotatably positioning the device in the blocking position is preceded by disconnecting the magnetic component of the device from the second corresponding magnetic component. Furthermore, the step of rotatably positioning the device in the blocking position is followed by connecting the magnetic component of the device to the first corresponding magnetic component. Each of the first and second corresponding magnetic components are disposed on the door and/or the door frame. In embodiments, a portion or an entirety of the door and/or door frame is/are magnetic.

Any device or step to a method described in this disclosure can comprise or consist of that which it is a part of, or the parts which make up the device or step. The term “and/or” is inclusive of the items which it joins linguistically and each item by itself.

### BRIEF DESCRIPTION OF THE DRAWINGS

FIG. 1 shows a top and left perspective view of a rapid lockdown device of embodiments of the disclosed technology.

FIG. 2 shows a bottom and right perspective view of the device of FIG. 1.

FIG. 3 shows a bottom and right perspective view of a rapid lockdown device of other embodiments of the disclosed technology.

FIG. 4 shows a bottom and right perspective view of a rapid lockdown device of other embodiments of the disclosed technology.

FIG. 5 shows a top and right perspective view of the rapid lockdown device of FIG. 4 attached to a door in a blocking position.

FIG. 6 shows a top and right perspective view of the rapid lockdown device of FIG. 4 attached to a door in a first unblocking position.

FIG. 7 shows a top and right perspective view of the rapid lockdown device of FIG. 4 attached to a door in a second unblocking position.

FIG. 8 shows a front elevation view of the rapid lockdown device of FIG. 4 attached to a door in a second unblocking position.

FIG. 9 shows a front elevation view of the rapid lockdown device of FIG. 4 attached to a door in a first unblocking position.

FIG. 10 shows a front elevation view of the rapid lockdown device of FIG. 4 attached to a door in a blocking position.

FIG. 11 shows a top cutaway view of the rapid lockdown device of FIG. 4 attached to a doorpost in an unblocking position.

FIG. 12 shows a top cutaway view of the rapid lockdown device of FIG. 4 attached to a doorpost in a blocking position.

### DETAILED DESCRIPTION OF EMBODIMENTS OF THE DISCLOSED TECHNOLOGY

A rapid lockdown device of embodiments of the disclosed technology includes a planar component rotatable about a screw portal located at a first end thereof. The planar component is adapted to be rotatably held against a strike plate of a door post via a screw extending through the screw portal. The device is rotatable into at least two positions: A blocking position, wherein the rectangular planar component is situated between a latch bolt of the door and a door frame; and an unblocking position, wherein the rectangular planar component, while being held by the screw to the strike plate, is positioned such that movement of the latch bolt towards the door frame is unencumbered.

Embodiments of the disclosed technology will become more clear in view of the following discussion of the figures.

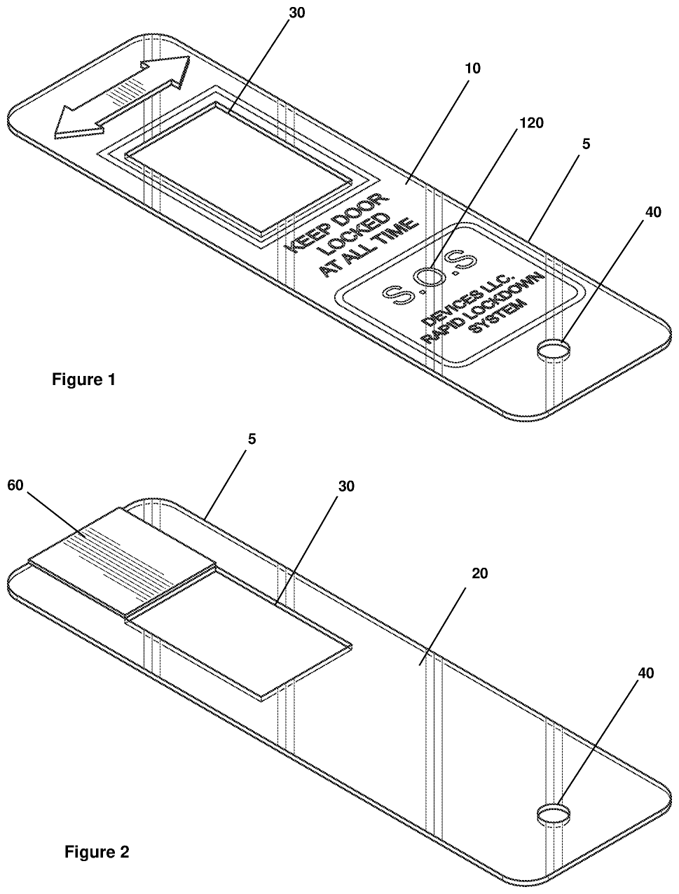

FIG. 1 shows a top and left perspective view of a rapid lockdown device of embodiments of the disclosed technology. The device, in embodiments, includes a rectangular planar component 5. In some embodiments, the rectangular planar component 5 has rounded corners. In various embodiments, the planar component 5 includes, on a front face 10 thereof, indicia 120, including printed, raised, etched, and/or engraved indicia 120. The indicia 120, in embodiments, include decoration, instructions for use of said device, and/or device names and/or logos.

The device, in embodiments, contains an internal cutout 30 and a screw hole 40. The screw hole 40, in some embodiments, is substantially at a midpoint between two longer edges of the planar component 5 and is substantially within a 20% of an area of the planar component 5 closest to a shorter edge thereof. The screw hole 40 may be substantially wide enough to allow a screw to be inserted therein such that the device is rotatable thereabout.

The internal cutout 30, in embodiments, is substantially at a midpoint between the two longer edges of the planar component 5 and is substantially closer to a shorter edge of the planar component 5 which is furthest from the screw hole 40. The internal cutout 30 may be wide enough that a normal adult's finger may be extended there-through with ease. In various embodiments, the internal cutout 30 may be of a square, rectangular, circular, or ovular shape.

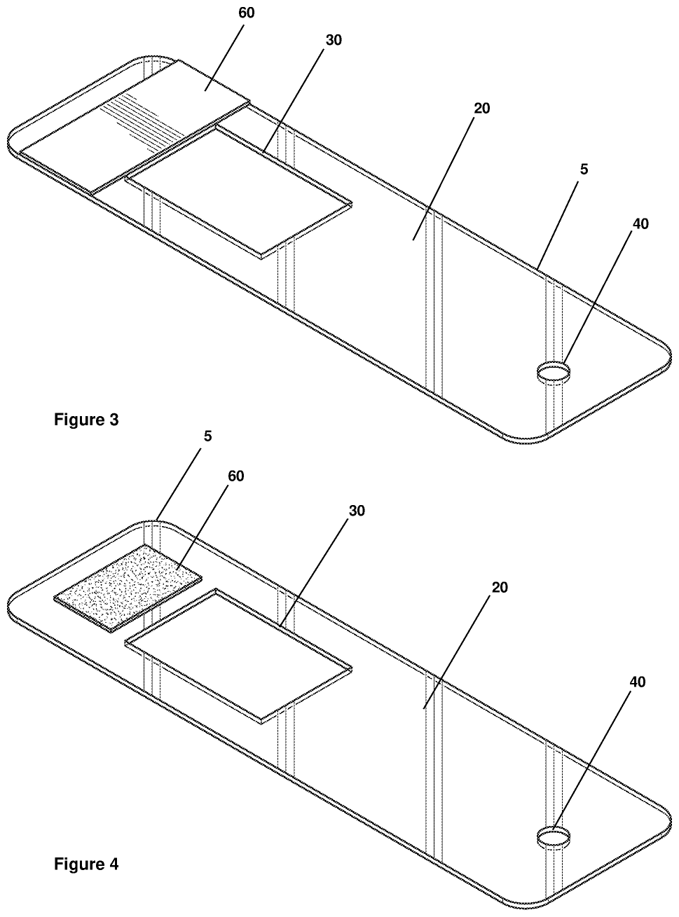

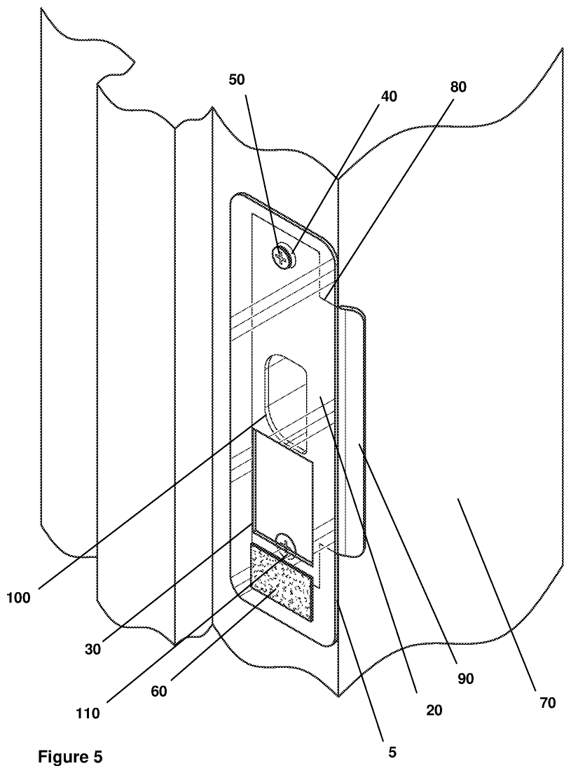

FIG. 2 shows a bottom and right perspective view of the device of FIG. 1. FIG. 3 shows a bottom and right perspective view of a rapid lockdown device of other embodiments of the disclosed technology. FIG. 4 shows a bottom and right perspective view of a rapid lockdown device of other embodiments of the disclosed technology. The device, in embodiments, includes an internal stabilizing component 60. The internal stabilizing component 60, in various embodiments, renders the device substantially immobile when the internal stabilizing component 60 is between, and substantially flush against each of, a back face 20 of the planar component 5 and a surface of a door 60, such that the device remains substantially in a same place unless acted upon by an outside force other than normal force due to gravity. The stabilizing effect of the internal stabilizing component 60 may be in effect when the device is in a blocking and/or unblocking position.

In some embodiments, the internal stabilizing component 60 has a greater frictional coefficient than a rest of the device, such that friction between the internal stabilizing component 60 and a part of a door 70 corresponding thereto, in one or both of a blocking and an unblocking position, is greater than friction between the rest of the device and parts of the door 70 corresponding thereto and/or is sufficient to render the device substantially immobile (as defined above).

The door 70 may include at least one corresponding internal component which has a greater frictional coefficient than a rest of the door 70, such that friction between the internal stabilizing component 60 and the at least one corresponding internal component is greater than friction between the internal stabilizing component 60 and a rest of the door 70. The at least one corresponding internal component, in embodiments, is located at a position corresponding to a position of the internal stabilizing component 60 when the device is in an unblocking position and/or a position of the internal stabilizing component 60 when the device is in a blocking position.

In embodiments, the internal stabilizing component 60 is of a magnetic and/or ferrous material, such that a magnetic force generated between the internal stabilizing component 60 and a part of a door 70 corresponding thereto, in one or both of a blocking and an unblocking position, is sufficient to render the device substantially immobile (as defined above).

The door 70 may include at least one corresponding internal component which is of a magnetic and/or ferrous material, such that a magnetic force generated between the at least one corresponding internal component and the internal stabilizing component 60, in one or both of a blocking and an unblocking position, is sufficient to render the device substantially immobile (as defined above). The at least one corresponding internal component, in embodiments, is located at a position corresponding to a position of the internal stabilizing component 60 when the device is in an unblocking position and/or a position of the internal stabilizing component 60 when the device is in a blocking position.

In other embodiments, the internal stabilizing component 60 is a hook and loop fastening male or female side, and the door 70 includes at least one corresponding hook and loop female or male side attached thereto. A connection between the male and female sides of the hook and loop fastening components, in embodiments, is strong enough to render the device substantially immobile (as defined above) when connected. The corresponding hook and loop female or male side attached to the door 70 may be positioned at a location corresponding to a location of the internal stabilizing component 60 in at least one blocking and/or in at least one unblocking position of the device.

In the embodiments shown, the internal stabilizing component 60 is substantially rectangular, and is located within an area between an edge of the internal rectangular cutout 30 farthest from the screw hole 40 and a shorter edge of the device closes to the edge of the internal rectangular cutout 30 farthest from the screw hole 40. In various other embodiments, the internal stabilizing component 60 may be of any shape, and may be in any location, such that it renders the device relatively immobile (as defined above) in at least one of a blocking and/or an unblocking position of the device. Furthermore, the device may include more than one internal stabilizing component 60 at more than one location thereof. The more than one internal stabilizing components 60 may all have a single corresponding internal component of the door 70, or may each have an individual corresponding internal component of the door 70. Each of the more than one internal stabilizing components 60 may be of any form described above (hooks and loops, magnetic, frictional) or of any other form which restricts and/or resists movement, so long as the more than one internal stabilizing components 60, individually or in totality thereof, render the device relatively immobile (as defined above) in at least one of a blocking and/or an unblocking position of the device.

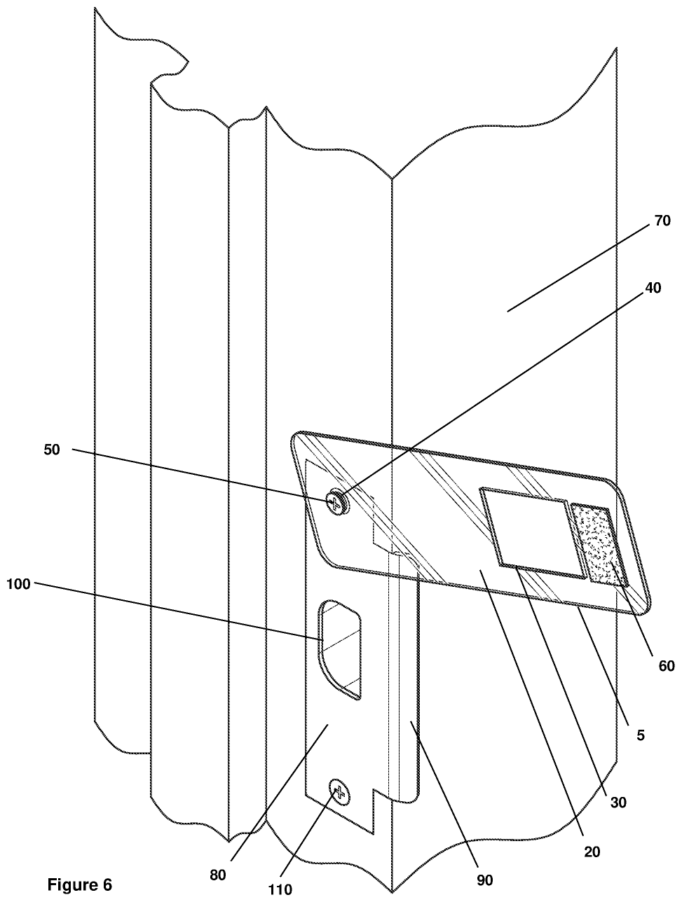

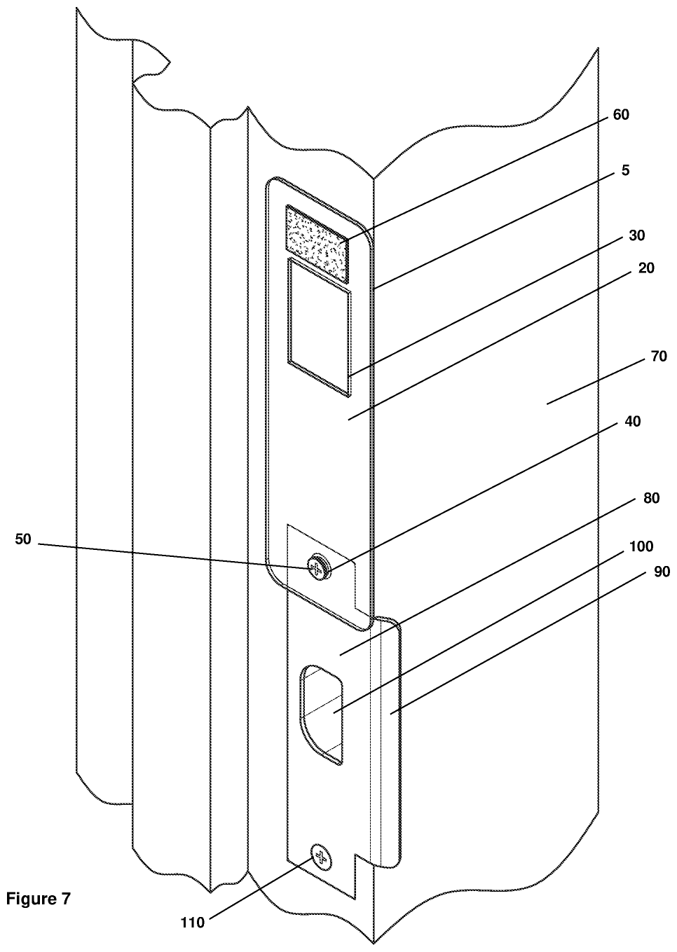

FIG. 5 shows a top and right perspective view of the rapid lockdown device of FIG. 4 attached to a door in a blocking position. FIG. 6 shows a top and right perspective view of the rapid lockdown device of FIG. 4 attached to a door in a first unblocking position. FIG. 7 shows a top and right perspective view of the rapid lockdown device of FIG. 4 attached to a door in a second unblocking position.

In the embodiment shown, the device is rotatably positionable about the screw hole 40, when a screw 50 is inserted there-through, into at least one blocking position and at least one unblocking position. A “blocking position” is defined as any rotatably achievable position of the device relative to the door 70 in which a latch bolt 130 is encumbered by the device, such that a normal force pushing the latch bolt 130 through a latch hole 100 of the door 70 is insufficient to cause the latch bolt 130 to extend through the latch hole 100 of the door 70. An “unblocking position” is defined as any rotatably achievable position of the device relative to the door 70 in which the latch bolt 130 is unencumbered by the device, such that the normal force pushing the latch bolt 130 through the latch hole 100 of the door 70 is sufficient to cause the latch bolt 130 to extend through the latch hole 100 of the door 70.

In the blocking positions, the device may substantially fully or partially cover the latch hole 100 so long as the latch bolt 130 is encumbered by the device, as described above. Similarly, in the unblocking positions, the device may partially cover the latch hole 100, or may leave the latch hole 100 substantially fully uncovered, so long as the latch bolt 130 is unencumbered by the device, as described above.

In the embodiment shown, the internal stabilizing component 60 of the device is disposed on the back face 20 of the device, and the front face 10 of the device is arranged to be flush with a surface of the door 70 and/or a surface of a lock 80 of the door 70. In these embodiments, the stabilizing effect of the internal stabilizing component 60 results from an interaction between the internal stabilizing component 60 and a doorpost opposite the door 70 and/or a part thereof and/or a corresponding internal component thereof. In other embodiments, the internal stabilizing component is disposed on the front face 10 of the device, such that the stabilizing effect of the internal stabilizing component 60 results from an interaction between the internal stabilizing component 60 and a the door 70 and/or a part thereof and/or a corresponding internal component thereof. In further embodiments, the device includes multiple internal stabilizing components 60 disposed on the front face 10 and on the back face 20 thereof, such that the stabilizing effect of the internal stabilizing component 60 results from an interaction between the internal stabilizing component 60 and a the door 70 and/or a part thereof and/or a corresponding internal component thereof as well as an interaction between the internal stabilizing component 60 and a doorpost opposite the door 70 and/or a part thereof and/or a corresponding internal component thereof.

The internal stabilizing component 60, in the embodiment shown, is disposed near a shorter edge of the device opposite a shorter edge thereof closest to the screw hole 40, such that the internal stabilizing component 60, of a portion thereof, is flush against the door 70 and/or a doorpost corresponding thereto in some rotatable positions of the device and is disconnected at its surface from the the door 70 and/or a doorpost corresponding thereto in other rotatable positions thereof. In various other embodiments, the internal stabilizing component 60 is located closer to the screw hole 40, such that it is flush against the door 70 and/or a doorpost corresponding thereto in a greater number of rotatable positions of the device as compared to the embodiment shown. In further embodiments, multiple internal stabilizing components 60 are disposed at various distances from the screw hole 40.

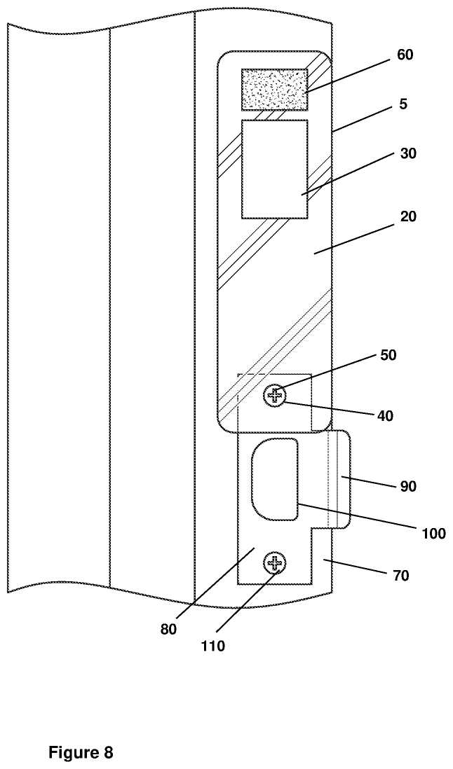

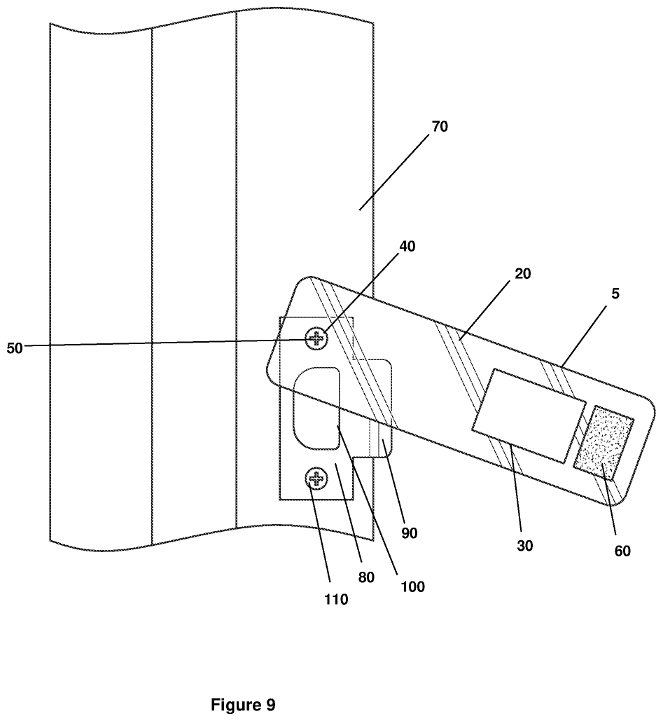

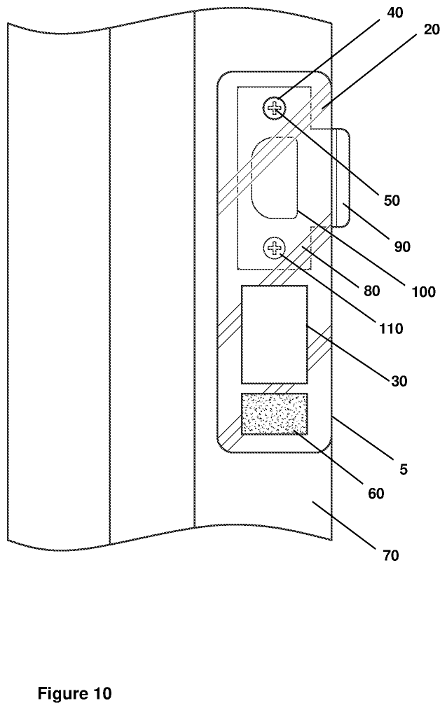

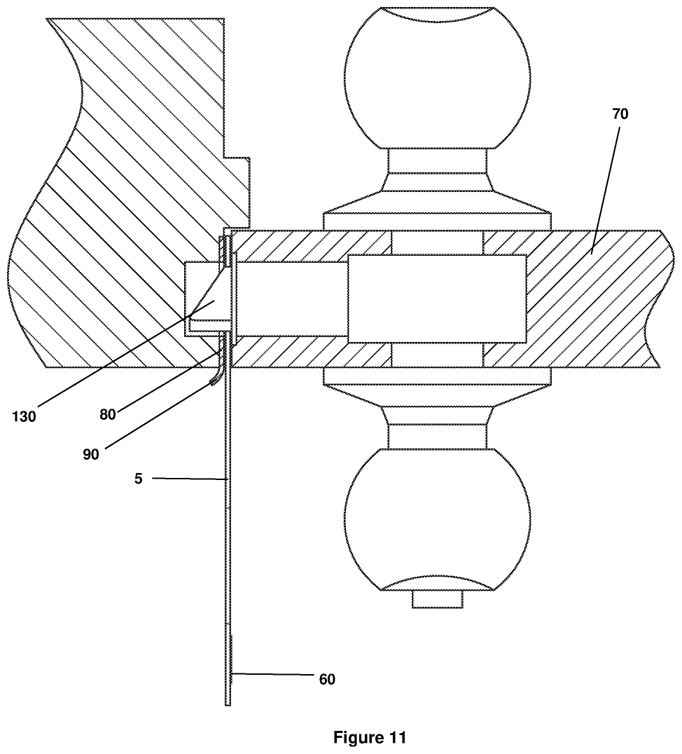

FIG. 8 shows a front elevation view of the rapid lockdown device of FIG. 4 attached to a door in a second unblocking position. FIG. 9 shows a front elevation view of the rapid lockdown device of FIG. 4 attached to a door in a first unblocking position. FIG. 10 shows a front elevation view of the rapid lockdown device of FIG. 4 attached to a door in a blocking position.

In the embodiment shown, a width of the device is substantially less than a width of the door 70 and/or a width of an area of the lock 80 which is flush against the door 70 and/or a width of an area of the lock 80 excluding a side lip 90 thereof when the device is rotatably positioned such that a longer side thereof is parallel to a face of the door 70 which contains the lock 80, either in a blocking position or in an unblocking position. The width of the device is defined as a distance from a point on a longer side thereof to a corresponding point on an opposite longer side thereof. The width of the lock 80 is similarly defined as a distance between a point on a longer side of the lock 80 and a point on an opposite side thereof, where the point on the opposite side thereof is outside of an area of the lip 90 thereof. In various embodiments, when the device is rotatably positioned such that a longer side thereof is parallel to a face of the door 70 which contains the lock 80, either in a blocking position or in an unblocking position, a longer side thereof is flush against an edge of the door 70 between a face of the door 70 which contains the lock 80 and a face adjacent thereto. In embodiments, the device includes a component which extends beyond a width of a rest of the device, such that at least the component extends beyond an edge of the door 70 when the device is rotatably positioned in a blocking and/or an unblocking position.

In various embodiments, the shape of the device relative to the door 70 is such that when the door 70 is closed and the device is rotatably positioned such that a longer edge thereof is parallel to a longer edge of a face of the door 70 containing the lock 80, a size of a gap between the device and a doorpost corresponding to the door 70 is small enough that the device is substantially unreachable by normal human fingers, at least for purposes of rotatably positioning and/or repositioning the device relative to the door 70, while the door 70 is closed.

In the embodiment shown, a length of the device is longer than a length of the lock 80. The length of the device is defined as a distance between a point on a shorter edge thereof and a corresponding point on an opposite shorter edge thereof. The length of the lock 80 is defined as a distance between a point on a vertically-highest edge thereof and a corresponding point on a vertically-lowest edge thereof, where the term “vertically” is used with reference to the door, such that highest” refers to a direction toward a point of the door 70 closest to a ceiling (when the door 70 is installed in a doorway) and “lowest” refers to a direction toward a point of the door 70 closest to a floor (when the door 70 is installed in a doorway). In various embodiments, the device may be of any length, so long as the device is rotatably positionable in at least one blocking and at least one unblocking position (in accordance with the descriptions given above).

In the embodiment shown, the device is rotatably connected to the door 70 by way of a screw 50 which simultaneously extends through the screw hole 40 of the device and through a screw hole of the lock 80, thus simultaneously securing both the device and the lock 80 to the door 70. In embodiments, the device is secured to the door 70 by a screw 50 extending through its screw hole 40 at a point within the door 70 which is vertically above a vertically highest point within the door 70 where the lock 80 is attached. In other embodiments, the device is secured to the door 70 by a screw 50 extending through its screw hole 40 at a point within the door 70 which is vertically below a vertically highest point within the door 70 where the lock 80 is attached, such that the screw 50 secures the device to the door 70 at a point between a vertically highest point within the door 70 where the lock 80 is attached and a vertically lowest point within the door 70 where the lock 80 is attached. In further embodiments, the screw 50 which simultaneously extends through the screw hole 40 of the device and through a screw hole of the lock 80 is located at a vertically lowest point within the door 70 where the lock 80 is attached.

The lock 80, in embodiments, is further attached to the door 70 by way of a second screw 110 which is located at a point of the lock opposite the screw 50. In the embodiment shown, when the device is in at least one blocking position, a portion of the device is flush against the second screw 110. In other embodiments, the relative lengths of the lock 80 and the device are such that an entirety of a surface of the device is unconnected to an entirety of a surface of the second screw 110 in substantially all blocking and unblocking positions into which the device is rotatably positionable.

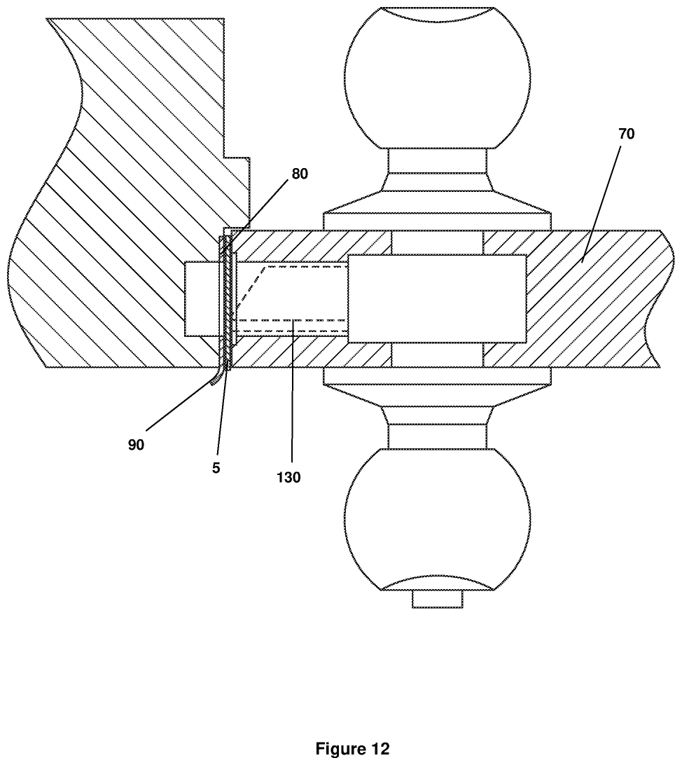

FIG. 11 shows a top cutaway view of the rapid lockdown device of FIG. 4 attached to a doorpost in an unblocking position. FIG. 12 shows a top cutaway view of the rapid lockdown device of FIG. 4 attached to a doorpost in a blocking position.

In the embodiment shown, the device is rotatably attached to the doorpost corresponding to the door 70. In this embodiment, when the device is rotatably positioned in a blocking position, a latch bolt 130 within the door 70 is blocked by the device from extending into a corresponding hole within the doorpost. Also in this embodiment, when the door 70 is open and the device is in a blocking position, the latch bolt 130 is unencumbered, such that it may fully extend from the door 70, so long as it does not extend into the corresponding hole within the doorpost. In these embodiments, a component corresponding to the device's internal stabilizing component 60 may be disposed on the door 70 at a point thereof corresponding to a location of the internal stabilizing component 60 in at least one blocking position and/or in at least one unblocking position.

In other embodiments, the device is rotatably attached to the door 70. In these embodiments, when the device is rotatably positioned in a blocking position, the latch bolt 130 within the door 70 is substantially blocked by the device from extending outwardly from the door 70, regardless of a position of the door 70 relative to the doorpost. The device may have a rigidity such that the device remains substantially fully flush against a face of the door 70 from which the latch bolt 130 extends despite a force of the latch bolt 130 pushing against the device, regardless of a position of the door 70 relative to the doorpost. In these embodiments, a component corresponding to the device's internal stabilizing component 60 may be disposed on the doorpost at a point thereof corresponding to a location of the internal stabilizing component 60 in at least one blocking position and/or in at least one unblocking position.

For purposes of this disclosure, the term “substantially” is defined as “at least 95% of” the term which it modifies.

Any device or aspect of the technology can “comprise” or “consist of” the item it modifies, whether explicitly written as such or otherwise.

When the term “or” is used, it creates a group which has within either term being connected by the conjunction as well as both terms being connected by the conjunction.

While the disclosed technology has been disclosed with specific reference to the above embodiments, a person having ordinary skill in the art will recognize that changes can be made in form and detail without departing from the spirit and the scope of the disclosed technology. The described embodiments are to be considered in all respects only as illustrative and not restrictive. All changes that come within the meaning and range of equivalency of the claims are to be embraced within their scope. Combinations of any of the methods and apparatuses described hereinabove are also contemplated and within the scope of the invention.

1. A rapid lockdown device, comprising:
a rotatable planar component; and
a screw portal substantially at a first end of said planar component;
wherein said planar component is adapted to be rotatably held against a strike plate of a door post via a screw extending through said screw portal;
wherein a most elongated flat side of said planar component is rotatable within a plane parallel to said strike plate about said screw into at least two positions:
a blocking position, wherein said rectangular planar component is situated between a latch bolt of said door and a door frame; and
an unblocking position, wherein said rectangular planar component, while being held by said screw to said strike plate, is positioned such that movement of said latch bolt towards said door frame is unencumbered.

2. The rapid lockdown device of claim 1, further comprising an internal rectangular cutout;
wherein said planar component is substantially rectangular;
wherein said screw portal is substantially circular;
wherein a width of said device, comprising a distance between a point of a first largest planar face thereof and a corresponding point of a second largest planar face thereof, is less than a width between a point of said door post and a corresponding point of a door corresponding thereto.

3. The rapid lockdown device of claim 1, further comprising:
a hook and loop fastening male or female side;
wherein a corresponding opposite female or male hook and loop fastening side is disposed on said door and/or on a doorpost at a location corresponding to said hook and loop fastening when said device is in said blocking position.

4. The rapid lockdown device of claim 1, further comprising:
a magnet on said planar component;
wherein a corresponding magnet is disposed on said doorpost and/or on said door at a location corresponding to said magnet when said planar component is in said blocking position.

5. The rapid lockdown device of claim 1, further comprising:
a magnet on said planar component;
wherein said doorpost and/or said door comprises, fully or partially, a corresponding magnet;
wherein magnetic force exerted between said magnet and said corresponding magnet is insufficient to cause said device to rotate from said unblocking position to said blocking position; and
wherein said magnetic force exerted between said magnet and said corresponding magnet is sufficient to substantially immobilize said device in said blocking position unless acted upon by external forces greater than and/or in a different vector from typical force due to gravity.

6. The rapid lockdown device of claim 1, further comprising:
an internal rectangular portion with a friction coefficient substantially higher than a friction coefficient of a rest of said device;
wherein said higher friction coefficient of said internal rectangle is sufficient to keep said device substantially immobile, at least with respect to rotation about said screw in at least said blocking and said unblocking position when said device is between said door and a corresponding door post and/or door frame.

7. The rapid lockdown device of claim 1, wherein said screw portal is substantially vertically above said latch bolt, such that in said blocking position, said device is substantially at a same angle to said door as said strike plate and said screw portal is above a majority of said device.

8. The rapid lockdown device of claim 1, wherein a width of said device is smaller than a width of said strike plate and/or said door post, such that when said device is substantially at a same angle to said door post as said strike plate, substantially an entirety of said device is between a plane corresponding to a front of said door post and a plane corresponding to a back of said door post;
wherein said front of said door post and said back of said door post are substantially perpendicular to said strike plate.

9. The rapid lockdown device of claim 1, further comprising indicia on a face thereof opposite a face thereof corresponding to said door post, such as instructions for using said device and/or emergency procedures.

10. The rapid lockdown device of claim 1, wherein in at least said blocking position, a vertical length of said device is equal to or greater than a vertical length of said door lock.

11. A method of using the above-described rapid lockdown device of claim 1, comprising steps of:
rotatably positioning said device in said blocking position;
locking said door, such that said latch bolt is extended from said door and is impeded by said device; and
rotatably positioning said device in said unblocking position, such that said latch bolt is extended from said door and is unencumbered by said device.

12. The method of claim 11, further comprising steps of:
before said step of rotatably positioning said device in said blocking position, opening said door;
following said step of rotatably positioning said device in said blocking position, closing said door, such that said device is located between said strike panel and a latch bolt of said door;
before said step of rotatably positioning said device in said unblocking position, opening said door; and
following said step of rotatably positioning said device in said unblocking position, closing said door, such that said device is located between said door frame and said door.

13. The method of claim 11, wherein said steps of rotatably positioning said device in said blocking and/or said unblocking position comprises rotating said device by exerting pressure within an internal rectangular cutout.

14. The method of claim 11, further comprising:
before said step of rotatably positioning said device in said unblocking position, disconnecting a hook and loop component of said device from a first corresponding hook and loop component at a position corresponding to said blocking position;
following said step of rotatably positioning said device in said unblocking position, connecting said hook and loop component of said device to a second corresponding hook and loop component at a position corresponding to said unblocking position;
before said step of rotatably positioning said device in said blocking position, disconnecting said hook and loop component of said device from said second corresponding hook and loop component; and
following said step of rotatably positioning said device in said blocking position, connecting said hook and loop component of said device to said first corresponding hook and loop component;
wherein said first and said second corresponding hook and loop components are disposed on said door and/or said door frame.

15. The method of claim 11, further comprising:
before said step of rotatably positioning said device in said unblocking position, disconnecting a magnetic component of said device from a first corresponding magnetic component at a position corresponding to said blocking position;
following said step of rotatably positioning said device in said unblocking position, connecting said magnetic component of said device to a second corresponding magnetic component at a position corresponding to said unblocking position;
before said step of rotatably positioning said device in said blocking position, disconnecting said magnetic component of said device from said second corresponding magnetic component; and
following said step of rotatably positioning said device in said blocking position, connecting said magnetic component of said device to said first corresponding magnetic component;
wherein said first and said second corresponding magnetic components are disposed on said door and/or said door frame.

16. The method of claim 15, wherein a portion or an entirety of said door and/or said door frame is magnetic.
